(19) United States
(12) Patent Application Publication
(10) Pub. No.: US 2022/0294666 A1
(43) Pub. Date: Sep. 15, 2022

(54) METHOD FOR SUPPORT OF ARTIFICIAL INTELLIGENCE OR MACHINE LEARNING TECHNIQUES FOR CHANNEL ESTIMATION AND MOBILITY ENHANCEMENTS

(71) Applicant: Samsung Electronics Co., Ltd., Suwon-si (KR)

(72) Inventors: Jeongho Jeon, San Jose, CA (US); Qiaoyang Ye, San Jose, CA (US); Joonyoung Cho, Portland, OR (US)

(21) Appl. No.: 17/653,442

(22) Filed: Mar. 3, 2022

Related U.S. Application Data
(60) Provisional application No. 63/157,485, filed on Mar. 5, 2021.

(51) Int. Cl. H04L 25/02; H04W 52/14

(52) U.S. Cl. CPC H04L 25/0202; H04W 52/146

(57) ABSTRACT

ML/AI configuration information for one of UL channel prediction, DL channel estimation, or cell selection/reselection includes: one or more of enabling/disabling an ML approach for the UL channel prediction, the DL channel estimation, or cell selection/reselection; one or more ML models to be used for the UL channel prediction, the DL channel estimation, or cell selection/reselection: trained model parameters for the one or more ML models for the UL channel prediction, the DL channel estimation, or cell selection/reselection; and/or whether ML model parameters for the UL channel prediction, the DL channel estimation, or cell selection/reselection received from the UE at the base station will be used. The ML/AI configuration information is transmitted from a BS to a UE, and the UE transmits UE assistance information for updating the one or more ML models for the UL channel prediction, the DL channel estimation or cell selection/reselection to the BS.

### CROSS-REFERENCE TO RELATED APPLICATION AND CLAIM OF PRIORITY

This application claims priority to U.S. Provisional Patent Application No. 63/157,485 filed Mar. 5, 2021. The content of the above-identified patent document(s) is incorporated herein by reference.

### TECHNICAL FIELD

The present disclosure relates generally to machine learning and/or artificial intelligence in communications equipment, and more specifically to support for ML/AI techniques in channel estimation and mobility enhancement.

### BACKGROUND

To meet the demand for wireless data traffic having increased since deployment of 4^{th} Generation (4G) or Long Term Evolution (LTE) communication systems and to enable various vertical applications, efforts have been made to develop and deploy an improved 5^{th} Generation (5G) and/or New Radio (NR) or pre-5G/NR communication system. Therefore, the 5G/NR or pre-5G/NR communication system is also called a “beyond 4G network” or a “post LTE system.” The 5G/NR communication system is considered to be implemented in higher frequency (mmWave) bands, e.g., 28 giga-Hertz (GHz) or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and technologies associated therewith is for reference as certain embodiments of the present disclosure may be implemented in 5G systems, 6^{th} Generation (6G) systems, or even later releases which may use terahertz (THz) bands. However, the present disclosure is not limited to any particular class of systems or the frequency bands associated therewith, and embodiments of the present disclosure may be utilized in connection with any frequency band. For example, aspects of the present disclosure may also be applied to deployment of 5G communication systems, 6G communications systems, or communications using THz bands.

### SUMMARY

ML/AI configuration information for one of UL channel prediction, DL channel estimation, or cell selection/reselection includes: one or more of enabling/disabling an ML approach for the UL channel prediction, the DL channel estimation, or cell selection/reselection; one or more ML models to be used for the UL channel prediction, the DL channel estimation, or cell selection/reselection: trained model parameters for the one or more ML models for the UL channel prediction, the DL channel estimation, or cell selection/reselection; and/or whether ML model parameters for the UL channel prediction, the DL channel estimation, or cell selection/reselection received from the UE at the base station will be used. The ML/AI configuration information is transmitted from a BS to a UE, and the UE transmits UE assistance information for updating the one or more ML models for the UL channel prediction, the DL channel estimation or cell selection/reselection to the BS.

In one embodiment, a UE includes a transceiver configured to receive, from a base station, ML/AI configuration information for one of UL channel prediction, DL channel estimation, or cell selection/reselection. The ML/AI configuration information includes: one or more of enabling/disabling an ML approach for the UL channel prediction, the DL channel estimation, or cell selection/reselection; one or more ML models to be used for the UL channel prediction, the DL channel estimation, or cell selection/reselection: trained model parameters for the one or more ML models for the UL channel prediction, the DL channel estimation, or cell selection/reselection; and/or whether ML model parameters for the UL channel prediction, the DL channel estimation, or cell selection/reselection received from the UE at the base station will be used. The transceiver is configured to transmit, to the base station, UE assistance information for updating the one or more ML models for the UL channel prediction, the DL channel estimation or cell selection/reselection. The UE includes a processor operatively coupled to the transceiver and configured to generate the UE assistance information for updating the one or more ML models for the UL channel prediction, the DL channel estimation, or cell selection/reselection based on the ML/AI configuration information.

In another embodiment a method includes receiving, at a UE from a base station, ML/AI configuration information for one of UL channel prediction, DL channel estimation, or cell selection/reselection. The ML/AI configuration information includes: one or more of enabling/disabling an ML approach for the UL channel prediction, the DL channel estimation, or cell selection/reselection; one or more ML models to be used for the UL channel prediction, the DL channel estimation, or cell selection/reselection; trained model parameters for the one or more ML models for the UL channel prediction, the DL channel estimation, or cell selection/reselection; and/or whether ML model parameters for the UL channel prediction, the DL channel estimation, or cell selection/reselection received from the UE at the base station will be used. The method includes generating, at the UE, UE assistance information for updating the one or more ML models for the UL channel prediction, the DL channel estimation, or cell selection/reselection based on the ML/AI configuration information. The method further includes transmitting, from the UE to the base station, the UE assistance information for updating the one or more ML models for the UL channel prediction, the DL channel estimation or cell selection/reselection.

In a third embodiment, a BS includes a transceiver configured to transmit, to a UE, ML/AI configuration information for one of UL channel prediction, DL channel estimation, or cell selection/reselection. The ML/AI configuration information includes: one or more of enabling/disabling an ML approach for the UL channel prediction, the DL channel estimation, or cell selection/reselection; one or more ML models to be used for the UL channel prediction, the DL channel estimation, or cell selection/reselection; trained model parameters for the one or more ML models for the UL channel prediction, the DL channel estimation, or cell selection/reselection; and/or whether ML model parameters for the UL channel prediction, the DL channel estimation, or cell selection/reselection received from the UE at the base station will be used. The transceiver is configured to receive, from the UE, UE assistance information for updating the one or more ML models for the UL channel prediction, the DL channel estimation or cell selection/reselection. The UE includes a processor operatively coupled to the transceiver and configured to generate the ML/AI configuration information.

For any of the above embodiments, the UE assistance information for updating the one or more ML models for the UL channel prediction may include one or more of: a UE inference on predicted UL channel status; an MCS index of an MCS autonomously selected by the UE for a following UL transmission based on the predicted channel status; ML model parameter updates based on local training for updating the one or more ML models for the UL channel prediction; and/or local data at the UE.

For any of the above embodiments, the UE may be configured to autonomously adjust transmission power by the transceiver for a following UL transmission based on a predicted UL channel status corresponding to an inference result at the UE.

For any of the above embodiments, a first DL reference signal pattern may be specified when an ML/AI approach for the DL channel estimation is enabled at the UE and a second DL reference signal pattern may be specified when an ML/AI approach for the DL channel estimation is disabled at the UE.

For any of the above embodiments, the ML/AI configuration information may include cell selection/reselection parameters. The UE assistance information relating to cell selection/reselection may be configured to be reported while the UE is in one of inactive mode or idle mode using a medium access control (MAC) control element (CE). A timer may restrict a frequency of reporting of the UE assistance information relating to cell selection/reselection.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an exemplary networked system utilizing artificial intelligence and/or machine learning according to various embodiments of this disclosure;

FIG. 2 illustrates an exemplary base station (BS) utilizing artificial intelligence and/or machine learning according to various embodiments of this disclosure;

FIG. 3 illustrates an exemplary electronic device for communicating in the networked computing system utilizing artificial intelligence and/or machine learning according to various embodiments of this disclosure;

FIG. 4 shows an example flowchart illustrating an example of BS operation to support AI/ML techniques for UL channel prediction according to embodiments of the present disclosure;

FIG. 5 shows an example flowchart illustrating an example of UE operation to support AI/ML techniques for UL channel prediction according to embodiments of the present disclosure;

FIG. 6 shows an example flowchart illustrating an example of BS operation to support AI/ML techniques for DL channel estimation according to embodiments of the present disclosure;

FIG. 7 shows an example flowchart illustrating an example of UE operation to support AI/ML techniques for DL channel estimation according to embodiments of the present disclosure;

FIG. 8 shows an example flowchart illustrating an example of BS operation to support AI/ML techniques for cell selection/reselection according to embodiments of the present disclosure;

FIG. 9 shows an example flowchart illustrating an example of UE operation to support AI/ML techniques for cell selection/reselection according to embodiments of the present disclosure; and

FIG. 10 shows an example of a new MAC CE for the UE assistance information report according to embodiments of the present disclosure.

### DETAILED DESCRIPTION

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

Abbreviations:

ML Machine Learning

AI Artificial Intelligence

gNB Next Generation Node B

BS Base Station

UE User Equipment

NR New Radio

3GPP 3rd Generation Partnership Project

SIB System Information Block

DCI Downlink Control Information

PDCCH Physical Downlink Control Channel

PDSCH Physical Downlink Shared Channel

PUCCH Physical Uplink Control Channel

PUSCH Physical Uplink Shared Channel

RRC Radio Resource Control

DL Downlink

UL Uplink

LTE Long-Term Evolution

BWP Bandwidth Part

MCS Modulation and Coding Scheme

Recent advances in artificial intelligence (AI) or machine learning (ML) have brought new opportunities in various application areas. Wireless communication is one of these areas starting to leverage AI/ML techniques to solve complex problems and improve system performance. The present disclosure relates generally to wireless communication systems and, more specifically, to supporting AI/ML techniques for channel estimation and mobility operations in wireless communication systems. The overall framework to support AI/ML techniques for channel estimation and mobility operations in wireless communication systems and corresponding signaling details are discussed in this disclosure.

The present disclosure relates to the support of AI/ML techniques in a communication system. Techniques, apparatus and methods are disclosed for configuration of AI/ML approaches for channel estimation and mobility operations, specifically the detailed configuration method for various AI/ML algorithms and corresponding model parameters, and signaling method for the support of training and inference operations at different components in the system for channel estimation and mobility operations have been discussed.

Aspects, features, and advantages of the disclosure are readily apparent from the following detailed description, simply by illustrating a number of particular embodiments and implementations. The subject matter of the disclosure is also capable of other and different embodiments, and several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

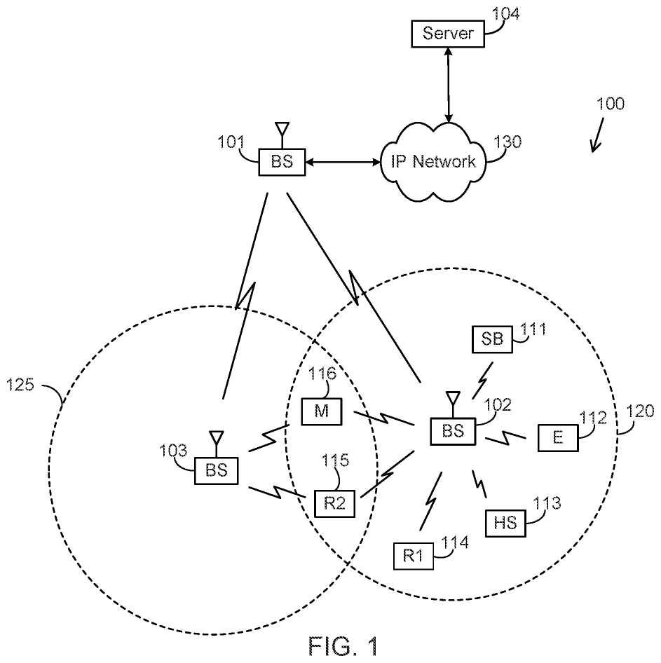

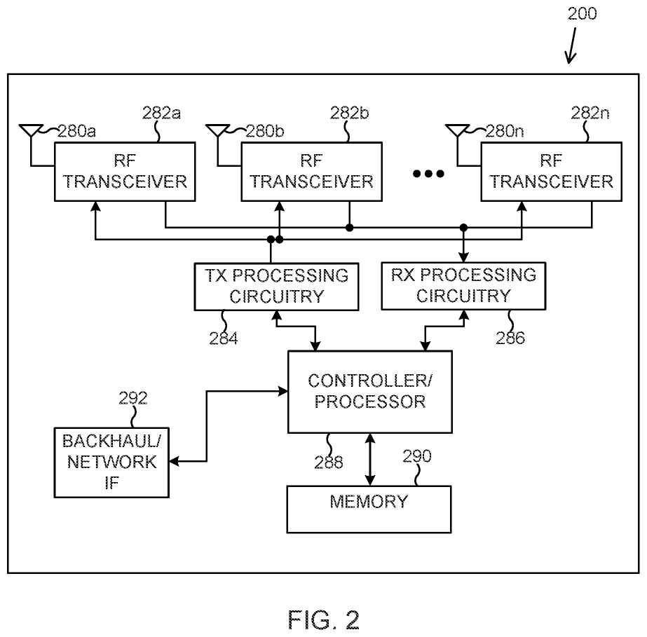

Throughout this disclosure, all figures such as FIG. 1, FIG. 2, and so on, illustrate examples according to embodiments of the present disclosure. For each figure, the corresponding embodiment shown in the figure is for illustration only. One or more of the components illustrated in each figure can be implemented in specialized circuitry configured to perform the noted functions or one or more of the components can be implemented by one or more processors executing instructions to perform the noted functions. Other embodiments could be used without departing from the scope of the present disclosure. In addition, the descriptions of the figures are not meant to imply physical or architectural limitations to the manner in which different embodiments may be implemented. Different embodiments of the present disclosure may be implemented in any suitably-arranged communications system.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

FIG. 1 illustrates an exemplary networked system utilizing artificial intelligence and/or machine learning in channel estimation and mobility enhancement according to various embodiments of this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a base station (BS) 101, a BS 102, and a BS 103. The BS 101 communicates with the BS 102 and the BS 103. The BS 101 also communicates with at least one Internet protocol (IP) network 130, such as the Internet, a proprietary IP network, or another data network.

The BS 102 provides wireless broadband access to the network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R1); a UE 115, which may be located in a second residence (R2); and a UE 116, which may be a mobile device (M) like a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G, LTE, LTE Advanced (LTE-A), WiMAX, WiFi, NR, or other wireless communication techniques.

Depending on the network type, other well-known terms may be used instead of “base station” or “BS,” such as node B, evolved node B (“eNodeB” or “eNB”), a 5G node B (“gNodeB” or “gNB”) or “access point.” For the sake of convenience, the term “base station” and/or “BS” are used in this disclosure to refer to network infrastructure components that provide wireless access to remote terminals. Also, depending on the network type, other well-known terms may be used instead of “user equipment” or “UE,” such as “mobile station” (or “MS”), “subscriber station” (or “SS”), “remote terminal,” “wireless terminal,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extent of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

Although FIG. 1 illustrates one example of a wireless network 100, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BS 101, 102, and/or 103 could provide access to other or additional external networks, such as external telephone networks or other types of data networks.

FIG. 2 illustrates an exemplary base station (BS) utilizing artificial intelligence and/or machine learning in channel estimation and mobility enhancement according to various embodiments of this disclosure. The embodiment of the BS 200 illustrated in FIG. 2 is for illustration only, and the BSs 101, 102 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 200 includes multiple antennas 280a-280n, multiple radio frequency (RF) transceivers 282a-282n, transmit (TX or Tx) processing circuitry 284, and receive (RX or Rx) processing circuitry 286. The BS 200 also includes a controller/processor 288, a memory 290, and a backhaul or network interface 292.

The RF transceivers 282a-282n receive, from the antennas 280a-280n, incoming RF signals, such as signals transmitted by UEs in the network 100. The RF transceivers 282a-282n down-convert the incoming RF signals to generate IF or baseband signals. The IF or baseband signals are sent to the RX processing circuitry 286, which generates processed baseband signals by filtering, decoding, and/or digitizing the baseband or IF signals. The RX processing circuitry 286 transmits the processed baseband signals to the controller/processor 288 for further processing.

The TX processing circuitry 284 receives analog or digital data (such as voice data, web data, e-mail, or interactive video game data) from the controller/processor 288. The TX processing circuitry 284 encodes, multiplexes, and/or digitizes the outgoing baseband data to generate processed baseband or IF signals. The RF transceivers 282a-282n receive the outgoing processed baseband or IF signals from the TX processing circuitry 284 and up-converts the baseband or IF signals to RF signals that are transmitted via the antennas 280a-280n.

The controller/processor 288 can include one or more processors or other processing devices that control the overall operation of the BS 200. For example, the controller/processor 288 could control the reception of forward channel signals and the transmission of reverse channel signals by the RF transceivers 282a-282n, the RX processing circuitry 286, and the TX processing circuitry 284 in accordance with well-known principles. The controller/processor 288 could support additional functions as well, such as more advanced wireless communication functions and/or processes described in further detail below. For instance, the controller/processor 288 could support beam forming or directional routing operations in which outgoing signals from multiple antennas 280a-280n are weighted differently to effectively steer the outgoing signals in a desired direction. Any of a wide variety of other functions could be supported in the BS 200 by the controller/processor 288. In some embodiments, the controller/processor 288 includes at least one microprocessor or microcontroller.

The controller/processor 288 is also capable of executing programs and other processes resident in the memory 290, such as a basic operating system (OS). The controller/processor 288 can move data into or out of the memory 290 as required by an executing process.

The controller/processor 288 is also coupled to the backhaul or network interface 292. The backhaul or network interface 292 allows the BS 200 to communicate with other devices or systems over a backhaul connection or over a network. The interface 292 could support communications over any suitable wired or wireless connection(s). For example, when the BS 200 is implemented as part of a cellular communication system (such as one supporting 6G, 5G, LTE, or LTE-A), the interface 292 could allow the BS 200 to communicate with other BS s over a wired or wireless backhaul connection. When the BS 200 is implemented as an access point, the interface 292 could allow the BS 200 to communicate over a wired or wireless local area network or over a wired or wireless connection to a larger network (such as the Internet). The interface 292 includes any suitable structure supporting communications over a wired or wireless connection, such as an Ethernet or RF transceiver.

The memory 290 is coupled to the controller/processor 288. Part of the memory 290 could include a RAM, and another part of the memory 290 could include a Flash memory or other ROM.

As described in more detail below, base stations in a networked computing system can be assigned as synchronization source BS or a slave BS based on interference relationships with other neighboring BSs. In some embodiments, the assignment can be provided by a shared spectrum manager. In other embodiments, the assignment can be agreed upon by the BSs in the networked computing system. Synchronization source BSs transmit OSS to slave BSs for establishing transmission timing of the slave BSs.

Although FIG. 2 illustrates one example of BS 200, various changes may be made to FIG. 2. For example, the BS 200 could include any number of each component shown in FIG. 2. As a particular example, an access point could include a number of interfaces 292, and the controller/processor 288 could support routing functions to route data between different network addresses. As another particular example, while shown as including a single instance of TX processing circuitry 284 and a single instance of RX processing circuitry 286, the BS 200 could include multiple instances of each (such as one per RF transceiver). Also, various components in FIG. 2 could be combined, further subdivided, or omitted and additional components could be added according to particular needs.

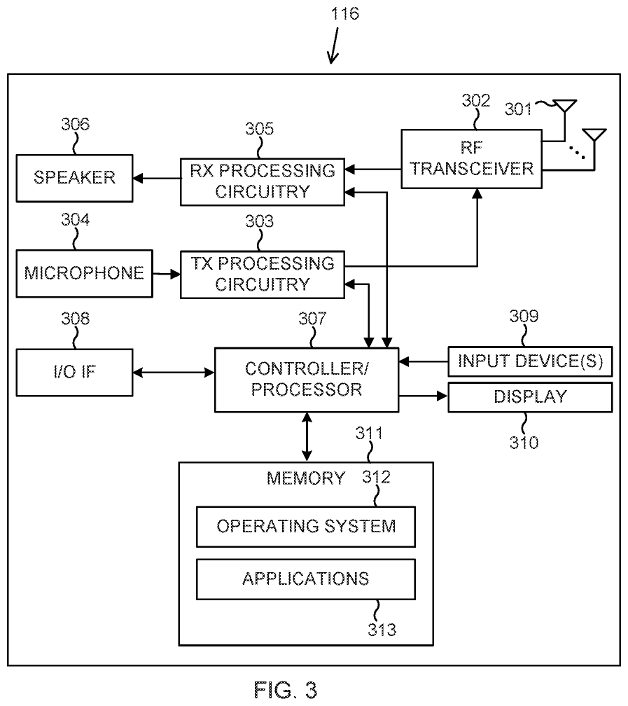

FIG. 3 illustrates an exemplary electronic device for communicating in the networked computing system utilizing artificial intelligence and/or machine learning in channel estimation and mobility enhancement according to various embodiments of this disclosure. The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller or processor 307, an input/output (I/O) interface (IF) 308, a touchscreen display 310, and a memory 311. The memory 311 includes an OS 312 and one or more applications 313.

The RF transceiver 302 receives, from the antenna 301, an incoming RF signal transmitted by an gNB of the network 100. The RF transceiver 302 down-converts the incoming RF signal to generate an IF or baseband signal. The IF or baseband signal is sent to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 can include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments, the processor 307 includes at least one microprocessor or microcontroller.

The processor 307 is also capable of executing other processes and programs resident in the memory 311, such as processes for channel station information (CSI) reporting on uplink channel. The processor 307 can move data into or out of the memory 311 as required by an executing process. In some embodiments, the processor 307 is configured to execute the applications 313 based on the OS 312 or in response to signals received from gNBs or an operator. The processor 307 is also coupled to the I/O interface 309, which provides the UE 116 with the ability to connect to other devices, such as laptop computers and handheld computers. The I/O interface 309 is the communication path between these accessories and the processor 307.

The processor 307 is also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 is coupled to the processor 307. Part of the memory 311 could include RAM, and another part of the memory 311 could include a Flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

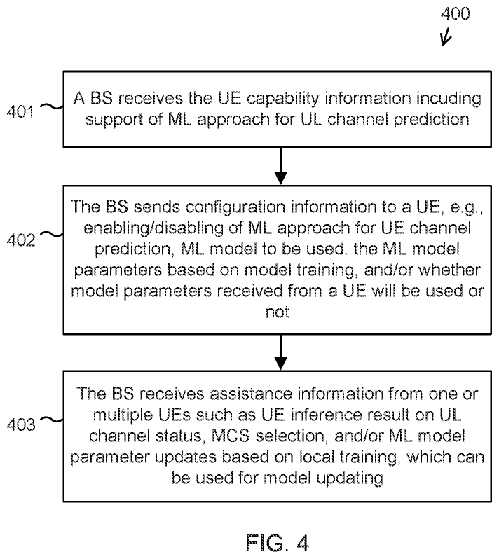

FIG. 4 shows an example flowchart illustrating an example of BS operation to support AI/ML techniques for UL channel prediction according to embodiments of the present disclosure.

FIG. 4 is an example of a method 400 for operations at the BS side to support AI/ML techniques for UL channel prediction. At operation 401, a BS receives the UE capability information from a UE, including the support of AI/ML approach for UL channel prediction. At operation 402, the BS sends the configuration information to the UE, which can include AI/ML related configuration information such as enabling/disabling of ML approach for UL channel prediction, ML model to be used, the trained model parameters, and/or whether the model parameter updates reported by the UE will be used or not. In one embodiment, the model training can be performed at the BS side. Alternatively, the model training can be performed at another network entity (e.g., RAN Intelligent Controller as defined in O-RAN), and trained model parameters can be sent to the BS. In yet another embodiment, the model training can be performed offline (e.g., model training is performed outside of the network), and the trained model parameters can be sent to the BS or a network entity. Part of or all the configuration information can be broadcasted as a part of cell-specific information, for example by system information such as MIB, SIB1 or other SIBs. Alternatively, part of or all the configuration information can be sent as UE-specific signaling, or group-specific signaling. More details about the signaling method are discussed below. At operation 106, the BS receives assistance information from one or multiple UEs. The assistance information can include UE inference result on UL channel status, MCS selection, and/or ML model parameter updates that can be used for model updating, as is subsequently described below.

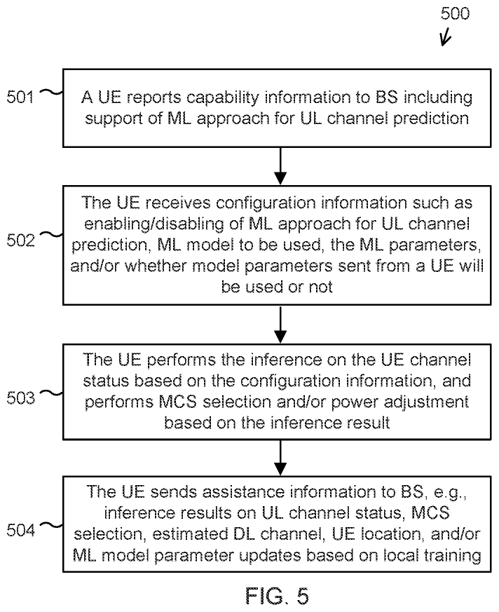

FIG. 5 shows an example flowchart illustrating an example of UE operation to support AI/ML techniques for UL channel prediction according to embodiments of the present disclosure.

FIG. 5 illustrates an example of a method 500 for operations at UE side to support AI/ML techniques for UL channel prediction. At operation 501, a UE reports capability information to BS, including support of ML approach for UL channel prediction. At operation 502, the UE receives configuration information, such as enabling/disabling of ML approach for UL channel prediction, ML model to be used, the trained model parameters, and/or whether the model parameter updates reported by the UE will be used or not. Part of or all the configuration information can be broadcasted as a part of cell-specific information, for example by system information such as MIB, SIB1 or other SIBs. Alternatively, part of or all the configuration information can be sent as UE-specific signaling, or group-specific signaling. More details about the signaling method are discussed below. At operation 503, the UE performs the inference based on the received configuration information and local data (which may include one or more of UE location, UE trajectory, estimated channel status, inference results, or updated model parameters). For example, the UE follows the configured ML model and model parameters, and uses local data and/or data sent from the BS, such as estimated DL channel (e.g., based on DL CSI reference signals (CSI-RSs) or demodulation reference signals (DMRSs)), the BS location and/or the UE location, etc., to perform the inference operation. In one example, the inference result can be predicted UL channel state. Based on the predicted UL channel state, the UE can autonomously select the MCS index and/or adjust the transmission power accordingly. In another example, the inference result can be the MCS index and/or transmission power for following UL transmission. At operation 504, the UE sends assistance information to the BS. The assistance information can include information such as local data at UE, inference results such as UL channel status, MCS selection and/or updated model parameters based on local training, etc., which can be used for model updating, as is subsequently described. In one example, federated learning approach can be predefined or configured, where UE may perform the model training based on local data available at UE and report the updated model parameters, according to the configuration (e.g., whether updated model parameters sent from the UE will be used or not).

For the embodiment where the UE autonomously selects the MCS index for UL transmission based on the inference result, the MCS index can be reported as a part of UCI carried in the PUCCH or PUSCH transmission. For example, the UCI can be multiplexed in the PUSCH, where a portion of the UCI carries the selected MCS index for the PUSCH. The MCS index for the UCI transmission can be predefined or semi-statically configured via RRC signaling. The BS can decode the UCI first, which would be transmitted at predefined resource elements (REs) with known MCS at the BS side, and based on the detected information, the corresponding MCS can be used for the remaining UL data reception in this PUSCH.

In one embodiment, the AI/ML techniques can be used for DL channel estimation.

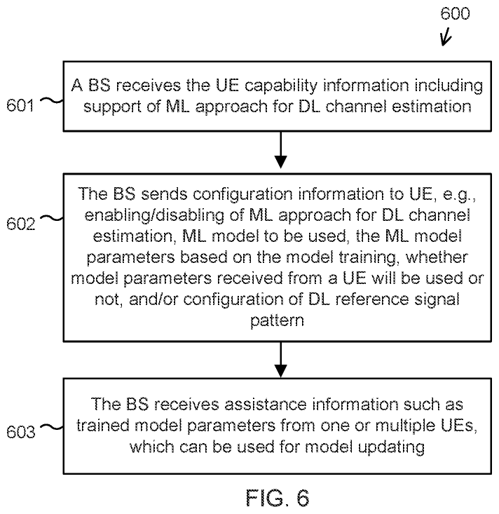

FIG. 6 shows an example flowchart illustrating an example of BS operation to support AI/ML techniques for DL channel estimation according to embodiments of the present disclosure.

FIG. 6 is an example of a method 600 for operations at the BS side to support AI/ML techniques for DL channel estimation. At operation 601, a BS receives the UE capability information from a UE, including the support of AI/ML approach for DL channel estimation. At operation 602, the BS sends configuration information to the UE, which can include AI/ML related configuration information such as enabling/disabling of ML approach for DL channel estimation, ML model to be used, the trained model parameters, whether the model parameter updates reported by the UE will be used or not, and/or DL reference signal pattern. For example, different DL reference signal (e.g., DMRS) patterns can be defined for the cases where AI/ML approach is enabled for DL channel estimation and the cases where AI/ML approach is disabled for DL channel estimation. Specifically, less dense DL reference signals may be used for the cases where the AI/ML approach is enabled for DL channel estimation. Two sets of DL reference signal patterns can be predefined, corresponding to the cases where the AI/ML approach is enabled and disabled for DL channel estimation, respectively. And one of the DL reference signal patterns can be configured out from the set of DL reference signal patterns, depending on whether the AI/ML approach is enabled or disabled. Regarding the model training operation, in one embodiment, the model training can be performed at the BS side. Alternatively, the model training can be performed at another network entity (e.g., RAN Intelligent Controller as defined in Open Radio Access Network (O-RAN)), and trained model parameters can be sent to the BS. In yet another embodiment, the model training can be performed offline (e.g., model training is performed outside of the network), and the trained model parameters can be sent to the BS or a network entity. Part or all of the configuration information can be broadcasted as a part of cell-specific information, for example by system information such as MIB, SIB1 or other SIBs. Alternatively, part or all of the configuration information can be sent as UE-specific signaling, or group-specific signaling. More details about the signaling method are discussed below. At operation 603, the BS receives assistance information from one or multiple UEs. The assistance information can include information to be used for model updating, as is subsequently described.

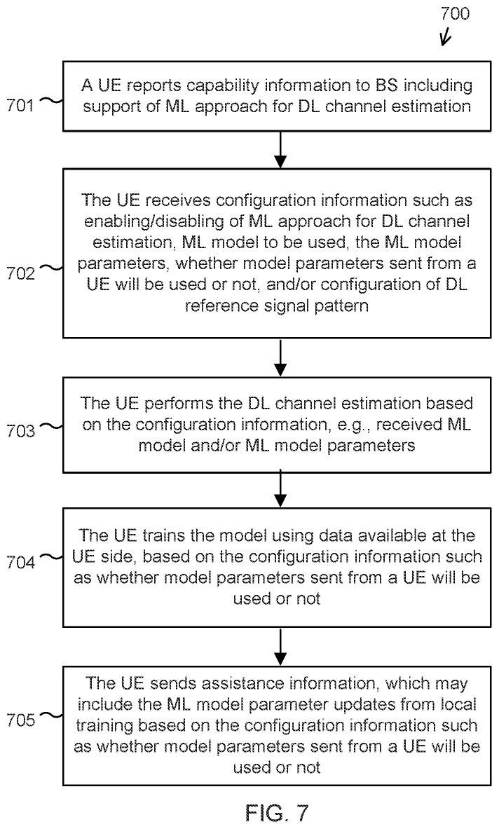

FIG. 7 shows an example flowchart illustrating an example of UE operation to support AI/ML techniques for DL channel estimation according to embodiments of the present disclosure.

FIG. 7 is an example of a method 700 for operations at the UE side to support AI/ML techniques for DL channel estimation. At operation 701, a UE reports its capability information to the BS, including the support of AI/ML approach for DL channel estimation. At operation 702, the UE receives configuration information, including information related to AI/ML techniques such as enabling/disabling of ML approach for DL channel estimation, the ML model to be used for DL channel estimation, the trained model parameters, whether the model parameter updates reported by the UE will be used or not, and/or the configuration of DL reference signal pattern (e.g., the DMRS configuration). Part of or all the configuration information can be broadcasted as a part of cell-specific information, for example by system information such as MIB, SIB1 or other SIBs. Alternatively, part of or all the configuration information can be sent as UE-specific signaling, or group-specific signaling. More details about the signaling method are discussed below. At operation 703, the UE performs the channel estimation based on the configuration information. For example, the UE follows the configured ML model, model parameters and DL reference signal pattern to perform the inference operation and get the estimated DL channel. At operation 704, the UE may train the model using data available at the UE side based on the configuration information. For example, the UE trains the model when the configuration is that the model parameter updates from the UE will be used for model updating. At operation 705, the UE sends assistance information to BS. The assistance information may include the updated model parameters based on local training, which can be used for model updating, as is subsequently described.

In one embodiment, the AI/ML techniques can be used for cell selection/reselection.

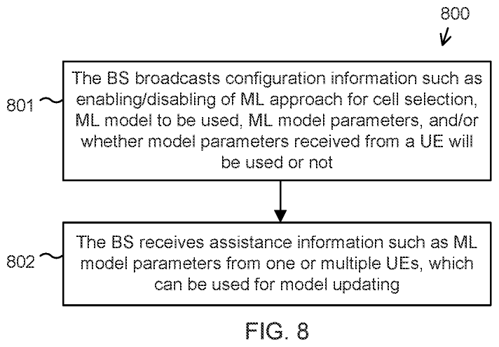

FIG. 8 shows an example flowchart illustrating an example of BS operation to support AI/ML techniques for cell selection/reselection according to embodiments of the present disclosure.

FIG. 8 is an example of a method 800 for operations at the BS side to support AI/ML techniques for cell reselection. At operation 801, a BS broadcasts the configuration information, which can include AI/ML related configuration information such as enabling/disabling of ML approach for cell selection/reselection, ML model to be used, the trained model parameters, and/or whether the model parameter updates reported by the UE will be used or not. In one example, the configuration information can also include cell selection/reselection parameters, e.g., part or all of the information provided by SIB3 and/or SIB4 in NR for cell selection/reselection such as the information carried in the information element (IE) IntraFreqNeighCellInfo and/or the IE InterFreqCarrierFreqInfo. In one embodiment, the model training can be performed at the BS side. Alternatively, the model training can be performed at another network entity (e.g., RAN Intelligent Controller as defined in O-RAN), and the trained model parameters can be sent to the BS. In yet another embodiment, the model training can be performed offline (e.g., model training is performed outside of the network), and the trained model parameters can be sent to the BS or a network entity. In another embodiment, federated learning can be used, where the BS or a network entity updates the model parameters based on the received model parameter updates from one or multiple UEs. The configuration information can be broadcasted as a part of cell-specific information, for example by system information such as MIB, SIB1 or other SIBs. At operation 802, the BS receives assistance information from one or multiple UEs. The assistance information can include information to be used for model updating, as is subsequently described.

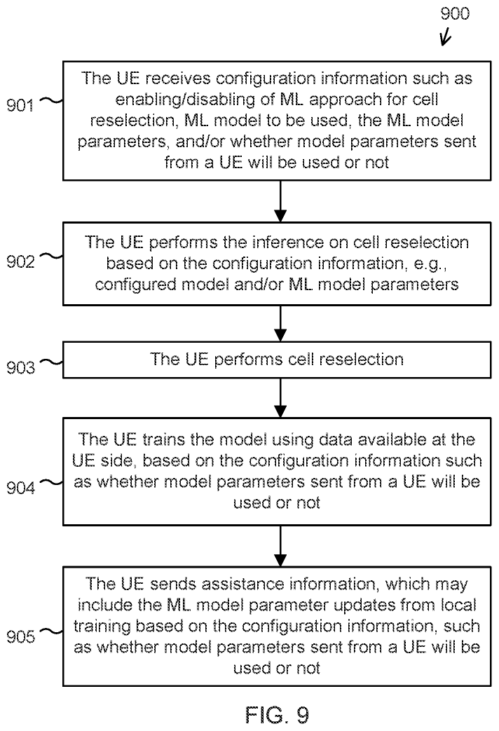

FIG. 9 shows an example flowchart illustrating an example of UE operation to support AI/ML techniques for cell selection/reselection according to embodiments of the present disclosure.

FIG. 9 is an example of a method 900 for operations at the UE side to support AI/ML techniques for cell selection/reselection. At operation 901, a UE receives configuration information, including information related to AI/ML techniques such as enabling/disabling of ML approach for cell selection/reselection, the ML model to be used for cell selection/reselection, the trained model parameters, and/or whether the model parameter updates reported by the UE will be used or not. At operation 902, the UE performs the inference on cell selection/reselection based on the configuration information. For example, the UE follows the configured ML model, model parameters and local available data to perform the inference operation for cell selection/reselection. At operation 903, the UE performs the cell reselection. For example, the cell reselection can be based on the inference result obtained by the UE. At operation 904, the UE may train the model using data available at the UE side based on the configuration information. For example, the UE trains the model when the configuration is that the model parameter updates from the UE will be used for model updating. At operation 905, the UE sends the assistance information to the BS. The assistance information may include the updated model parameters based on local training, which can be used for model updating. To report the assistance information, the following embodiments can be used.

In one embodiment, the UE assistance information can be reported in the inactive/idle mode, and a new medium access control-control element (MAC-CE) can be defined. This MAC-CE can be carried in Msg3 if a 4-step random access channel (RACH) procedure is used, or Msg1 if 2-step RACH procedure is used. The UE in inactive/idle mode would perform the RACH procedure to report the UE assistance information. Regarding the triggering of the report, in one example, the BS can broadcast the triggering event for the UE to report the assistance information, e.g., after a certain duration when the UE is in inactive/idle mode, or after certain times of cell selection/reselection measurement, or with a certain period for the reporting, etc. In another example, the configuration can leave up to the UE when to report the assistance information. A timer can be configured or predefined to restrict too frequent reporting, i.e., the timer can start after the UE sends a report and no additional report will be sent before the timer expires. If the timer is configurable, the timer configuration can be broadcasted by the BS, e.g., as a part of the configuration information for AI/ML approach for cell selection/reselection.

In another embodiment, the UE can wait until the UE becomes RRC connected to report the assistance information. In this case, the report can be designed similarly as other operations in RRC connected mode, as is subsequently described.

The configuration information related to AI/ML techniques (e.g., at operations 402, 502, 602, 702, 801 or 901) can include one or multiple of the following information:

Enabling/disabling of ML Approach for Different Use Cases

In one embodiment, the configuration information can include whether AI/ML techniques for certain operation/use case is enabled or disabled. One or multiple operations/use cases can be predefined. For example, there can be N predefined operations, with index 1, 2, . . . , N corresponding to one operation such as “UL channel prediction,” “DL channel estimation,” “cell selection/reselection,” etc., respectively. The configuration can indicate the indexes of the operations which are enabled, or there can be a Boolean parameter to enable or disable the AI/ML approach for each operation.

In one embodiment, the configuration information can include which AI/ML model or algorithm is to be used for certain operation/use case(s). For example, there can be M predefined ML algorithms, with index 1, 2, . . . , M, each corresponding to one ML algorithm such as linear regression, quadratic regression, reinforcement learning algorithms, deep neutral network, etc. In one example, the federated learning can be defined as one of the ML algorithm. Alternatively, there can be another parameter to define whether the approach is based on federated learning or not.

In another embodiment, the use case and AI/ML approach can be jointly configured. For example, there can be K predefined operation modes, where each mode corresponds to a certain operation/use case with a certain ML algorithm. One or more modes can be configured. TABLE 1 provides an example of this embodiment, where the configuration information can include one or multiple mode indices to enable the operations/use cases and ML algorithms. One or more columns in TABLE 1 can be optional in different embodiments. For example, the configuration for AI/ML approach for cell selection/reselection can be separate from the table, and indicated in different signaling method, e.g., broadcasted in system information (e.g., MIB, SIB1 or other SIBs), while the configuration information for AI/ML approach for other operations can be indicated via UE-specific or group-specific signaling.

TABLE 1
Example of AI/ML operation modes, where different operations/use cases,
ML algorithms and/or corresponding key model parameters can be predefined

| Mode | Operation/use case | ML algorithms | Model parameters |
|---|---|---|---|
| 1 | DL channel estimation | Regression | Features, weights, and/or |
| | | | regularization, etc. |
| 2 | DL channel estimation | Reinforcement learning | States, actions, transition |
| | | | probability, and/or reward |
| | | | function, etc. |
| 3 | UL channel prediction | Reinforcement learning | States, actions, transition |
| | | | probability, and/or reward |
| | | | function, etc. |
| 4 | Handover | Reinforcement learning | States, actions, transition |
| | | | probability, and/or reward |
| | | | function, etc. |
| 5 | Handover | Deep neutral network | Layers, number of neutrons |
| | | | each layer, weights and bias |
| | | | for connection between |
| | | | neutrons in different layers, |
| | | | activation function, inputs, |
| | | | and/or outputs, etc. |
| 6 | Handover | Federated learning | ML model such as loss |
| | | | function, initial parameters for |
| | | | the model, whether UE is |
| | | | configured for the training and |
| | | | reporting, local batch size for |
| | | | each learning iteration, and/or |
| | | | learning rate, etc. |
| . . . | | | |
| K | Cell reselection | Deep neutral network | Layers, number of neutrons |
| | | | each layer, weights and bias |
| | | | for connection between |
| | | | neutrons in different layers, |
| | | | activation function, inputs, |
| | | | and/or outputs, etc. |

The configuration information can include the model parameters of ML algorithms. In one embodiment, one or more of the following ML algorithms can be defined, and one or more of the model parameters listed below for the ML algorithms can be predefined or configured as part of the configuration information.

Supervised Learning Algorithms, such as Linear Regression, Quadratic Regression, Etc.

The model parameters for this type of algorithms can include features such as number of features and what the features are, weights for the regression, regularization such as L1 or L2 regularization and/or regularization parameters.

For example, the following regression model can be used, where

$$y ( x , w ) = {w}_{0} + {\sum }_{i}^{M - 1} {w}_{i} {∅}_{i} ( x ) ,$$

and the objective is

$${min}_{w} \frac{1}{2} {\sum }_{j}^{N} {‖ {y}^{( j )} - y ( {x}^{( j )} , w ) ‖}^{2} + \frac{λ}{2} {‖ w ‖}^{2} ,$$

with N being the number of training samples, M being the number of features, w being the weights, x^{(j)} and y^{(j)} being the jth training sample, Øᵢ(x) being the basis function (e.g., Øᵢ(x)=xᵢ for linear regression), λ being the regularization parameter and

$$\frac{λ}{2} {‖ w ‖}^{2}$$

being the L2 regularization term.

The model parameters for reinforcement learning algorithms can include set of states, set of actions, state transition probability, and/or reward function.

For example, the set of states can include UE location, satellite location, UE trajectory, and/or satellite trajectory for DL channel estimation, or include UE location, satellite location, UE trajectory, satellite trajectory, and/or estimated DL channel for UL channel prediction, or include location, satellite location, UE trajectory, satellite trajectory, estimated DL channel, measured signal to interference plus noise ratio (SINR), reference signal received power (RSRP) and/or reference signal received quality (RSRQ), current connected cell, and/or cell deployment for handover operation, etc.

As another example, the set of actions can include possible set of DL channel status for DL channel estimation, or include possible set of UL channel status, MCS indexes, and/or UL transmission power for UL channel prediction, or include set of cells to be connected to for handover operation, etc.

In yet another example, the state transition probability may not be available, and thus may not be included in as part of the model parameters. In this case, other learning algorithms such as Q-learning can be used.

The model parameters for deep neural networks can include the number of layers, the number of neutrons in each layer, the weights and bias for each neutron in previous layer to each neutron in the next layer, activation function, inputs such as input dimension and/or what the inputs are, outputs such as output dimension and/or what the outputs are, etc.

The model parameters of federated learning algorithms can include the ML model to be used such as the loss function, the initial parameters for the ML model, whether the UE is configured for the local training and/or reporting, the number of iterations for local training before polling, local batch size for each learning iteration, and/or learning rate, etc.

In one embodiment, part of or all the configuration information can be broadcasted as a part of cell-specific information, for example by system information such as MIB, SIB1 or other SIBs. Alternatively, a new SIB can be introduced for the indication of configuration information. For example, the enabling/disabling of ML approach, ML model and/or model parameters for certain operation/use case can be broadcasted, such as the enabling/disabling of ML approach, which ML model to be used and/or model parameters for cell reselection operation can be broadcasted. TABLE 2 provides an example (new parameter indicated in boldface) of sending the configuration information via SIB1, where K operation modes are predefined and one mode can be configured. In other examples, multiple modes can be configured.

TABLE 2
Example of information element (IE) SIB 1 modification
for configuration of ML/AI techniques

| SIB1 ::= SEQUENCE { | | |
|---|---|---|
| cellSelectionInfo SEQUENCE { | | |
| q-RxLevMin | Q-RxLevMin, | |
| q-RxLevMinOffset | INTEGER | (1..8) |
| OPTIONAL, -- Need S | | |
| q-RxLevMinSUL | Q-RxLevMin | |
| OPTIONAL, -- Need R | | |
| q-QualMin | Q-QualMin | |
| OPTIONAL, -- Need S | | |
| q-QualMinOffset | INTEGER | (1..8) |

| OPTIONAL -- Need S | |
|---|---|
| } | |
| OPTIONAL, -- Cond Standalone | |
| ... | |
| ml-Operationmode | INTEGER (1..K) |
| ... | |
| nonCriticalExtension | SEQUENCE{ } |

OPTIONAL
}

In TABLE 2, ml-Operationmode indicates a combination of enabling of ML approach for a certain operation and the enabled ML model.

In another embodiment, part of or all the configuration information can be sent by UE-specific signaling. The configuration information can be common among all configured DL/UL BWPs or can be BWP-specific. For example, the UE-specific RRC signaling, such as an IE PDSCH-ServingCellConfig or an IE PDSCH-Config in IE BWP-DownlinkDedicated, can include configuration of enabling/disabling ML approach for DL channel estimation, which ML model to be used and/or model parameters for DL channel estimation. As another example, the UE-specific RRC signaling, such as an IE PUSCH-ServingCellConfig or an IE PUSCH-Config in IE BWP-UplinkDedicated, can include configuration of enabling/disabling ML approach for UL channel prediction, which ML model to be used and/or model parameters for UL channel prediction.

TABLE 3 provides an example of configuration for DL channel estimation via IE PDSCH-ServingCellConfig. In this example, the ML approach for DL channel estimation is enabled or disabled via a BOOLEAN parameter, and the ML model/algorithm to be used is indicated via index from 1 to M. In some examples, the combination of ML model and parameters to be used for the model can be predefined, with each index from 1 to M corresponding to a certain ML model and a set of model parameters. Alternatively, one or multiple ML model/algorithms can be defined for each operation/use case, and a set of parameters in the IE can indicate the values for model parameters correspondingly.

TABLE 3
Example of IE PDSCH-ServingCellConfig modification
for configuration of ML/AI techniques

| PDSCH-ServingCellConfig ::= | SEQUENCE { | |
|---|---|---|
| codeBlockGroupTransmission | SetupRelease { PDSCH- | |
| CodeBlockGroupTransmission } | OPTIONAL, | -- Need |

M

| | |
|---|---|
| xOverhead | ENUMERATED { xOh6, xOh12, |
| xOh18 } | OPTIONAL, -- Need S |

```
  ...,
  [[
```

| | | |
|---|---|---|
| maxMIMO-Layers | INTEGER | (1..8) |

OPTIONAL, -- Need M

| | |
|---|---|
| processingType2Enabled | BOOLEAN |

```
        OPTIONAL -- Need M
      ]],
      [[
  pdsch-CodeBlockGroupTransmissionList-r16 SetupRelease { PDSCH-
        CodeBlockGroupTransmissionList-r16 } OPTIONAL --
        Need M
  ]]
```

| | |
|---|---|
| processingType2Enabled | BOOLEAN |

OPTIONAL -- Need M

| | |
|---|---|
| pdsch-MlChEst | SEQUENCE { |
| mlEnabled | BOOLEAN |
| mlAlgo | INTEGER (1...M) |

...
}
}

In yet another embodiment, part of or all the configuration information can be sent by group-specific signaling. A UE group-specific RNTI can be configured, e.g. using value 0001-FFEF or the reserved value FFF0-FFFD. The group-specific RNTI can be configured via UE-specific RRC signaling. A grouping of UEs can be done in a various way considering the circumstances in which UEs are experiencing. Through common signaling for the group of UEs, the configuration of AI/ML operations can be tailored to each individual UE's situation while not incurring overhead due to individual signaling. For the UL channel prediction or DL channel estimation use cases, as an example, a precise channel state information (CSI) in both time and frequency domains is needed for channel whose variation is dependent on multipath delay profile and Doppler shift due to relative velocity between BS and UE. In one embodiment, UEs under similar multipath delay profile or Doppler shift can be grouped and assigned common RNTI. Then, the activation of AI/ML approach for a certain use case, configuration of AI/ML model, or configuration of parameters for a given AI/ML model can be done via group-common signaling. For the case of cell selection/reselection use case, as another example, the decision is based on average channel strength metrics such as RSRP and/or RSRQ. These metrics are dependent on UE speed, moving trajectory, and the level of inter-cell interference, etc. Therefore, UEs under similar moving speed/trajectory, and experienced level of inter-cell interference can be grouped and assigned common RNTI.

The UE assistance information related to ML/AI techniques (e.g., at operations 403, 504, 603, 705 or 802) can include one or multiple of the following information.

Information Available at the UE Side, such as UE Inference Result, MCS Selection, Etc.

Model parameters. For example, the updates of model parameters based on local training at UE side can be reported to BS, which can be used for model updates, e.g., in federated learning approaches. The report of the updated model parameters can depend on the configuration. For example, if it is configured that the model parameter updates from the UE would not be used, the UE may not report the model parameter updates. On the other hand, if the configuration is that the model parameter updates from the UE may be used for model updating, the UE may report the model parameter updates.

For connected mode UEs, the report of the assistance information can be via PUCCH and/or PUSCH. A new uplink control information (UCI) type, a new PUCCH format and/or a new MAC-CE can be defined for the assistance information report. The existing UCI in NR includes scheduling request (SR), hybrid automatic repeat request acknowledgement (HARQ ACK), and channel quality information (CQI). In addition to these existing UCI, a new UE assistance information (UAI) UCI can be defined. The UAI UCI can be comprised of the following:
UE Location: This field indicates the position of the UE in a pre-defined coordinate system, e.g. the Earth-Centered Earth-Fixed (ECEF) coordinate system.
UE speed: This field indicates UE moving speed in a certain unit, e.g., kilometers/hour (km/h) or miles/hour (mi/h). The current absolute UE speed or the relative speed change compared to previously signaled value can be indicated.
UE Trajectory: This field indicates the heading of the UE in a pre-defined coordinate system, e.g., the Earth-Centered Earth-Fixed (ECEF) coordinate system.
Estimated DL Delay Spread: This field indicates the UE's estimate of the DL channel's delay spread in nanoseconds. The delay spread can be divided into certain ranges of values and the index of the corresponding range can be indicated.
Estimated DL Doppler Spread: This field indicates the UE's estimate of the DL channel's Doppler spread in Hertz. The Doppler spread can be divided into certain ranges of values and the index of the corresponding range can be indicated.
Inference Result (IR): This field indicates the presence of the octet containing the Model Inference Result field. If the IR field is set to 1, the octet containing the Model Inference Result field is present. If the IR field is set to 0, the octet containing the Model Inference Result field is not present.
Model Inference Result: This field indicates the result of ML model inference at the UE. In one example, this field can include a measure of UL channel frequency/time domain channel selectivity, UL MCS, UL spatial layers, UL transmission power for UL channel prediction use case. In another example of DL channel estimation, the field can include HARQ ACK/negative acknowledgement (NACK) per transport block (TB), per code block group (CBG), or code block (CB). It can also include uncoded bit error rate (BER) for entire scheduled TB or with more fine granularity in time/frequency resource. The field can also include a certain measure of channel estimation errors. In another example of cell selection/reselection, the field can include the frequency of cell selection/reselection and a measure related to ping-pong effect.

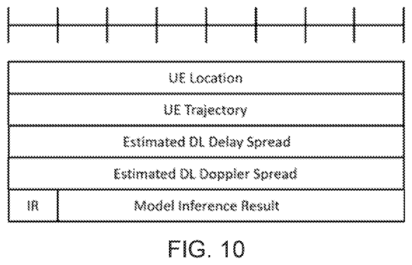

FIG. 10 shows an example of a new MAC CE for the UE assistance information report according to embodiments of the present disclosure. The UAI UCI comprises UE Location, UE Trajectory, Estimated DL Delay Spread, Estimated DL Doppler Spread, and the Model Inference Result fields.

Regarding the triggering method, in one embodiment, the report can be triggered periodically, e.g. via UE-specific RRC signaling.

In another embodiment, the report can be semi-persistence or aperiodic. For example, the report can be triggered by the DCI, where a new field (e.g., 1-bit triggering field) can be introduced to the DCI for the report triggering. In one example, an IE similar to IE CSI-ReportConfig can be introduced for the report configuration of UE assistance information to support AI/ML techniques. In yet another embodiment, the report can be triggered via certain event. For example, the UE can report the model parameter updates before it enters RRC inactive and/or idle mode. Whether UE should report the model parameter updates can additionally depend on the configuration, e.g. configuration via RRC signaling regarding whether the UE needs to report the model parameter updates.

TABLE 4 provides an example of the IE for the configuration of UE assistance information report, where whether the report is periodic or semi-persistent or aperiodic, the resources for the report transmission, and/or report contents can be included. The ‘parameter1’ to ‘parameterN’ and the possible values ‘X1’ to ‘XN’ and ‘Y1 to YN’ are listed as examples, while other possible methods for the configuration of model parameters are not excluded. Also, for the ‘UE-location’, if (as an example) a set of UE locations are predefined, and the UE can report one of the predefined location via the index L1, L2, etc. However, other methods for report of UE location are not excluded.

TABLE 4
Example of IE for configuration of UE assistance information
report for support of ML/AI techniques

| | |
|---|---|
| MIReport-ReportConfig ::= | SEQUENCE { |
| reportConfigId | MlReport-ReportConfigid, |
| reportConfigType | CHOICE { |
| periodic | SEQUENCE { |
| reportSlotConfig | MlReport- |

ReportPeriodicityAndOffset,

| | | |
|---|---|---|
| pucch-MIReport-ResourceList | SEQUENCE | (SIZE |

```
        (1..maxNrofBWPs)) OF PUCCH-MIReport-Resource
    },
```

| | |
|---|---|
| semiPersistentOnPUCCH | SEQUENCE { |
| reportSlotConfig | MlReport- |

ReportPeriodicityAndOffset,

| | | |
|---|---|---|
| pucch-MIReport-ResourceList | SEQUENCE | (SIZE |

```
        (1..maxNrofBWPs)) OF PUCCH-MIReport-Resource
    },
```

| semiPersistentOnPUSCH | SEQUENCE { | |
|---|---|---|
| reportSlotConfig | ENUMERATED | {s15, |

s110, s120, s140, s180, s1160, s1320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH-AlphaSetId |

},

| aperiodic | SEQUENCE { | |
|---|---|---|
| reportSlotOffsetList | SEQUENCE | (SIZE |

```
(1..maxNrofUL-Allocations)) OF INTEGER(0..32)
    }
  },
```

| | |
|---|---|
| reportQuantity | CHOICE { |
| none | NULL, |
| model-parameters | SEQUENCE { |
| parameter1 | INTEGER (−X1..Y1) |
| parameter2 | INTEGER (−X2..Y2) |

...

| | |
|---|---|
| parameterN | INTEGER (−XN..YN) |

}

| | |
|---|---|
| UE-location | ENUMERATED {L1, L2, ...} |

...
},
MlReport-ReportPeriodicityAndOffset ::= CHOICE {

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-mlReport-Resource ::= | SEQUENCE { |
| uplinkBandwidthPartId | BWP-Id, |
| pucch-Resource | PUCCH-ResourceId |

}
...
}

Although this disclosure has been described with an exemplary embodiment, various changes and modifications may be suggested to one skilled in the art. It is intended that this disclosure encompass such changes and modifications as fall within the scope of the appended claims.

What is claimed is:

1. A user equipment (UE), comprising:
a transceiver configured to receive, from a base station, machine learning/artificial intelligence (ML/AI) configuration information for one of uplink (UL) channel prediction, downlink (DL) channel estimation, or cell selection/reselection, the ML/AI configuration information including
one or more of enabling/disabling an ML approach for the UL channel prediction, the DL channel estimation, or cell selection/reselection,
one or more ML models to be used for the UL channel prediction, the DL channel estimation, or cell selection/reselection,
trained model parameters for the one or more ML models for the UL channel prediction, the DL channel estimation, or cell selection/reselection, or
whether ML model parameters for the UL channel prediction, the DL channel estimation, or cell selection/reselection received from the UE at the base station will be used; and
a processor operatively coupled to the transceiver, the processor configured to generate UE assistance information for updating the one or more ML models for the UL channel prediction, the DL channel estimation, or cell selection/reselection based on the ML/AI configuration information,
wherein the transceiver is further configured to transmit the UE assistance information for updating the one or more ML models for the UL channel prediction, the DL channel estimation or cell selection/reselection.

2. The UE of claim 1, wherein the UE assistance information for updating the one or more ML models for the UL channel prediction includes one or more of
a UE inference on predicted UL channel status,
a modulation and coding scheme (MCS) index of an MCS autonomously selected by the UE for a following UL transmission based on the predicted channel status,
ML model parameter updates based on local training for updating the one or more ML models for the UL channel prediction, or
local data at the UE.

3. The UE of claim 1, wherein local data at the UE comprises one or more of UE location, UE trajectory/mobility, UE speed, UE orientation, UE battery level, estimated delay and Doppler spread, experienced error rate, experienced quality of service, estimated channel status, inference results, or updated model parameters.

4. The UE of claim 1, wherein the transceiver is further configured to autonomously adjust transmission power for a following UL transmission based on a predicted UL channel status corresponding to an inference result at the UE.

5. The UE of claim 4, wherein the inference result at the UE comprises one or more of predicted channel state, modulation and coding scheme (MCS) index selection, transmission frequency range selection, transmission time resource selection, transmission timing advancement, or transmission power.

6. The UE of claim 1, wherein a first DL reference signal pattern is specified when an ML/AI approach for the DL channel estimation is enabled at the UE and a second DL reference signal pattern is specified when an ML/AI approach for the DL channel estimation is disabled at the UE.

7. The UE of claim 1, wherein the ML/AI configuration information includes cell selection/reselection parameters, and wherein one of
the UE assistance information relating to cell selection/reselection is configured to be reported while the UE is in one or inactive mode of idle mode using a medium access control (MAC) control element (CE), or
a timer restricts a frequency of reporting of the UE assistance information relating to cell selection/reselection.

8. A method, comprising:
receiving, at a user equipment (UE) from a base station, machine learning/artificial intelligence (ML/AI) configuration information for one of uplink (UL) channel prediction, downlink (DL) channel estimation, or cell selection/reselection, the ML/AI configuration information including
one or more of enabling/disabling an ML approach for the UL channel prediction, the DL channel estimation, or cell selection/reselection,
one or more ML models to be used for the UL channel prediction, the DL channel estimation, or cell selection/reselection,
trained model parameters for the one or more ML models for the UL channel prediction, the DL channel estimation, or cell selection/reselection, or
whether ML model parameters for the UL channel prediction, the DL channel estimation, or cell selection/reselection received from the UE at the base station will be used;
generating, at the UE, UE assistance information for updating the one or more ML models for the UL channel prediction, the DL channel estimation, or cell selection/reselection based on the ML/AI configuration information; and
transmitting, from the UE to the base station, the UE assistance information for updating the one or more ML models for the UL channel prediction, the DL channel estimation or cell selection/reselection.

9. The method of claim 8, wherein the UE assistance information for updating the one or more ML models for the UL channel prediction includes one or more of
a UE inference on predicted UL channel status,
a modulation and coding scheme (MCS) index of an MCS autonomously selected by the UE for a following UL transmission based on the predicted channel status,
ML model parameter updates based on local training for updating the one or more ML models for the UL channel prediction, or
local data at the UE.

10. The method of claim 8, wherein local data at the UE comprises one or more of UE location, UE trajectory/mobility, UE speed, UE orientation, UE battery level, estimated delay and Doppler spread, experienced error rate, experienced quality of service, estimated channel status, inference results, or updated model parameters.

11. The method of claim 8, further comprising:
autonomously adjusting transmission power for a following UL transmission based on a predicted UL channel status corresponding to an inference result at the UE.

12. The method of claim 11, wherein the inference result at the UE comprises one or more of predicted channel state, modulation and coding scheme (MCS) index selection, transmission frequency range selection, transmission time resource selection, transmission timing advancement, or transmission power.

13. The method of claim 8, wherein a first DL reference signal pattern is specified when an ML/AI approach for the DL channel estimation is enabled at the UE and a second DL reference signal pattern is specified when an ML/AI approach for the DL channel estimation is disabled at the UE.

14. The method of claim 8, wherein the ML/AI configuration information includes cell selection/reselection parameters, and wherein one of
the UE assistance information relating to cell selection/reselection is configured to be reported while the UE is in one or inactive mode or idle mode using a medium access control (MAC) control element (CE), or
a timer restricts a frequency of reporting of the UE assistance information relating to cell selection/reselection.

15. A base station (BS), comprising:
a processor configured to generate machine learning/artificial intelligence (ML/AI) configuration information for one of uplink (UL) channel prediction, downlink (DL) channel estimation, or cell selection/reselection, the ML/AI configuration information including
one or more of enabling/disabling an ML approach for the UL channel prediction, the DL channel estimation, or cell selection/reselection,
one or more ML models to be used for the UL channel prediction, the DL channel estimation, or cell selection/reselection,
trained model parameters for the one or more ML models for the UL channel prediction, the DL channel estimation, or cell selection/reselection, or
whether ML model parameters for the UL channel prediction, the DL channel estimation, or cell selection/reselection received from the UE at the base station will be used, and
a transceiver operably coupled to the processor and configured to
transmit the ML/AI configuration information to a user equipment (UE), and
receive, from the UE, UE assistance information for updating the one or more ML models for the UL channel prediction, the DL channel estimation or cell selection/reselection.

16. The BS of claim 15, wherein the UE assistance information for updating the one or more ML models for the UL channel prediction includes one or more of
a UE inference on predicted UL channel status,
a modulation and coding scheme (MCS) index of an MCS autonomously selected by the UE for a following UL transmission based on the predicted channel status,
ML model parameter updates based on local training for updating the one or more ML models for the UL channel prediction, or
local data at the UE.

17. The BS of claim 16, wherein the local data at the UE comprises one or more of UE location, UE trajectory/mobility, UE speed, UE orientation, UE battery level, estimated delay and Doppler spread, experienced error rate, experienced quality of service, estimated channel status, inference results, or updated model parameters.

18. The BS of claim 15, wherein the transceiver is further configured to receive a following UL transmission from the UE at a transmission power autonomously adjusted based on a predicted UL channel status corresponding to an inference result at the UE.

19. The BS of claim 15, wherein a first DL reference signal pattern is specified when an ML/AI approach for the DL channel estimation is enabled at the UE and a second DL reference signal pattern is specified when an ML/AI approach for the DL channel estimation is disabled at the UE.

20. The BS of claim 15, wherein the ML/AI configuration information includes cell selection/reselection parameters, and wherein one of
the UE assistance information relating to cell selection/reselection is configured to be reported while the UE is in one of inactive mode or idle mode using a medium access control (MAC) control element (CE), or
a timer restricts a frequency of reporting of the UE assistance information relating to cell selection/reselection.
